(19) United States
(12) Patent Application Publication
(10) Pub. No.: US 2010/0045787 A1
(43) Pub. Date: Feb. 25, 2010

(54) AUTHENTICATING APPARATUS, AUTHENTICATING SYSTEM, AND AUTHENTICATING METHOD

(75) Inventor: Kazuya UNO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/500,584

(22) Filed: Jul. 9, 2009

(30) Foreign Application Priority Data
Aug. 19, 2008 (JP) 2008-211082

(51) Int. Cl. H04N 7/18; G06K 9/00

(52) U.S. Cl. 348/77; 382/115; 382/218; 348/E07.085

(57) ABSTRACT

An authenticating apparatus that authenticates whether a user is a registrant based on biometric information includes a biometric information input unit to input the biometric information, a registered information memory unit to memorize, together with a single or plural registrants of the biometric information, registered biometric information for each of the registrants, an identification candidate information memory unit to memorize candidate information representing registrants selected from the registrants of the registered information memory unit, and an identifying unit to compare the biometric information of the user input to the biometric information input unit and the registered biometric information of the registered information memory unit to decide on a single registrant or select plural registrants based on similarity, and, when plural registrants are selected, memorize the plural registrants in the identification candidate information memory unit as candidate information to use the candidate information as objects to be identified for biometric information of a subsequent input.

### CROSS-REFERENCE TO RELATED APPLICATION

This application is based upon and claims the benefit of priority of the prior Japanese Patent Application No. 2008-211082, filed on Aug. 19, 2008, the entire contents of which are incorporated herein by reference.

### FIELD

The embodiments discussed herein are related to authentication using biometric information of a fingerprint, etc., and, to an authenticating apparatus, an authenticating system, and an authenticating method that are used in 1-to-N-identification biometric authentication and authenticate whether a user is a registrant registered in advance.

### BACKGROUND

Biometric authentication is roughly classified into a 1-to-1 system and a 1-to-N system. The 1-to-N system is a system of performing identity authentication with biometric information alone without using other identity determining means (unit) such as ID inputting in combination therewith. The 1-to-N system generally has an identity determining threshold decided for similarity, compares the similarity obtained by sequentially comparing the biometric information acquired from a user and pieces of the registered biometric information registered beforehand with the identity determining threshold, and performs the identity determination depending on whether the similarity is equal to or more than the identity determining threshold.

The 1-to-N system, which does not require the ID inputting, etc. as other identity determining means (unit), has an advantage of high convenience for the user. However, the 1-to-N system, which needs to determine the similarity by performing processing of comparing with all (N pieces) of the registered biometric information as objects to be identified, has a problem of a long authenticating time and a heavy processing load on an authenticating apparatus.

In the biometric authentication, the biometric information of the user is not necessarily input steadily due to physical condition of the user and environmental elements, etc., surrounding the user and it is conceivable that one time of inputting is not enough for uniquely identifying the user and false rejection occurs or the authentication succeeds only after several times of inputting. Especially in the 1-to-N system, since, due to a high possibility of accepting different identity as compared with the 1-to-1 system, the threshold of accepting the identity is highly set, the false rejection is apt to occur. This causes plural times of inputting and an increase in authentication processing time per user. This is expected to contribute to dissatisfaction with a long authenticating time and a load on a CPU in the authenticating apparatus (especially in a large-scale server authenticating model).

There is an other conventional technique of decreasing the number of pieces of data (N) as objects to be identified by performing pre-identification classifying processing (binning) based on fingerprint characteristics and other information and thereafter performing comparison processing. Such decrease in the number of pieces of data is expected to have the effect of shortening the time for the identification processing.

There is a system of establishing priority order of processing of comparing with pieces of the registered information as objects to be identified, discontinuing the identification processing at the time of reaching such piece of the registered information at which the similarity exceeds a predetermined threshold, and finishing the identity determination as successful, in consideration of utilization characteristics of the application or the system as object to be authenticated (Japanese Laid-Open Patent Publication Nos. 11-312250 and 2007-206942).

Japanese Laid-Open Patent Publication No. 11-312250 discloses the technique of specifying whether such piece of the registered information by which the identity determination is made as a result of certain authentication is to be used as the object to be identified at the time of subsequent authentication, or changing the priority order of comparing in the identification. That is to say, this Japanese Laid-Open Patent Publication No. 11-312250 discloses the system having the function of being capable of specifying whether a dictionary element (registered template) by which the identity recognition is made as a result of the 1:N identification is to be used or not as checking dictionary data in subsequent 1:N identification and the function of changing the priority order of checking in the subsequent 1:N identification.

Japanese Laid-Open Patent Publication No. 2007-206942 discloses, in a system of performing processing of sequentially comparing with pieces of the registered information based on a priority order table at the time of identification and determining the identity when a piece of the registered information can be determined as matching with the user's information, the technique of updating the priority order table so that the priority order of comparing will be raised for such piece of the registered information by which the identity is determined. That is to say, this Japanese Laid-Open Patent Publication No. 2007-206942 discloses, in the system of sequentially checking with pieces of the registered data, based on the priority order table and determining the identity when there is a match, in the 1:N identification, the technique of updating the priority order table by raising the priority order of such piece of the registered data that is identified at the time of successful identification.

These systems (Japanese Laid-Open Patent Publication Nos. 11-312250 and 2007-206942) are intended for the results of the identity determination successfully made as expected, in the 1:N identification and, in respect of the identification processing system, merely deem a candidate first found in sequential checking as a match.

Japanese Laid-Open Patent Publication No. 2007-249556 discloses the technique of grouping pieces of the registered biometric data according to characteristic information and checking the input information with a specific group.

Performing the classification processing (narrowing-down) before the identification, however, may possibly cause a narrowing-down failure (binning error) and, in such a case, the registered biometric information of the user does not become the object to be identified and correct identification processing does not be executed. To minimize this narrowing-down failure is the problem to be solved.

The techniques disclosed in Japanese Laid-Open Patent Publication Nos. 11-312250 and 2007-206942, which do not perform the comparison with all pieces of the registered information as objects to be identified, have the problem that the occurrence rate of false identification of falsely determining the registered information of other than the particular user as that of the particular user is likely to be high as compared with the system of performing comparison with a whole of the objects to be identified.

Japanese Laid-Open Patent Publication Nos. 11-312250, 2007-206942, and 2007-249556 do not have any disclosure or suggestion with respect to such need or problem and any disclosure or suggestion with respect to configuration, etc. for the solution thereof.

### SUMMARY

According to one aspect of embodiments of the invention, an authenticating apparatus that authenticates whether a user is a registrant based on biometric information, the apparatus includes: a biometric information input unit to input the biometric information of the user; a registered information memory unit to memorize, together with a single or plural registrants of the biometric information, registered biometric information for each of the registrants; an identification candidate information memory unit to memorize candidate information representing registrants selected from the registrants of the registered information memory unit; and an identifying unit to compare the biometric information input to the biometric information input unit and the registered biometric information of the registered information memory unit to decide on a single registrant or select plural registrants based on similarity, and, when plural registrants are selected, memorize the plural registrants in the identification candidate information memory unit as candidate information to use the candidate information as objects to be identified for biometric information of a subsequent input.

According to such a configuration, since, besides the case of deciding on a single registrant, when plural registrants are selected, depending on the similarity by comparing the input biometric information of the user with the registered biometric information, such registrants are taken as pieces of candidate information and these pieces of the candidate information are taken as the objects to be identified against the biometric information to be input next time, a shorter time of authentication processing and the high-accuracy identity determination may be achieved, even if plural candidates are produced for the input biometric information of the user.

According to another aspect of embodiments of the invention, an authenticating system includes: a terminal device to input biometric information of a user; a storage device to memorize, together with a single or plural registrants of the biometric information, registered biometric information for each of the registrants; and an authenticating apparatus to compare the biometric information of the user input to a biometric information input unit of the terminal device and the registered biometric information of the storage device, decide on a single registrant or select plural registrants based on similarity, and, when plural registrants are selected, uses the selected registrants as objects to be identified for biometric information of a subsequent input.

Such a configuration enables judging by comparing the biometric information input through a terminal device with the registered biometric information, using a memory device and an authenticating apparatus separately disposed from the terminal device, performing the identification based on the similarity, and performing the identity authentication.

According to another aspect of embodiments of the invention, an authenticating method of authenticating whether a user is a registrant based on biometric information, the method includes: a biometric information inputting process to input the biometric information of the user; a registered information memorizing process to memorize, together with a single or plural registrants of the biometric information, registered biometric information for each of the registrants; an identification candidate information memorizing process to memorize candidate information representing registrants selected from the registrants; and an identifying process to compare the biometric information of the user to be input and the registered biometric information, decide on a single registrant or select plural registrants based on similarity, and, when plural registrants are selected, memorize the plural registrants as candidate information and using the candidate information as objects to be identified for biometric information of a subsequent input.

According to another aspect of embodiments of the invention, a computer-readable recording medium having recorded thereon an authenticating program executed by a computer, the program includes: capturing biometric information of a user to be input; memorizing, together with a single or plural registrants of the biometric information, registered biometric information for each of the registrants; memorizing candidate information representing registrants selected from the registrants; and comparing the biometric information of a user to be input and the registered biometric information to decide on a single registrant or select plural registrants based on similarity, and, when plural registrants are selected, memorizing the plural registrants as the candidate information to use the candidate information as objects to be identified for biometric information of a subsequent input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features, and advantages of the present invention will more clearly be understood with reference to the accompanying drawings and the embodiments.

### BRIEF DESCRIPTION OF THE DRAWINGS

FIG. 1 is a block diagram of an authenticating apparatus according to a first embodiment;

FIG. 2 is a flowchart of a procedure of 1-to-N identification processing of biometric authentication of the authenticating apparatus;

FIGS. 3A to 3D are diagrams of one example of biometric information to be input and registered information to be identified;

FIGS. 4A to 4D are diagrams of one example of the biometric information to be input and synthesized biometric information;

FIG. 5 is a flowchart of a procedure of identification processing using narrowing-down;

FIG. 6 is a flowchart of a procedure of the identification processing using the narrowing-down;

FIG. 7 is a flowchart of a procedure of another identification processing using the narrowing-down;

FIG. 8 is a flowchart of a procedure of another identification processing using the narrowing-down;

FIG. 9 is a block diagram of a configuration example of an authenticating system according to a second embodiment;

FIG. 10 is a diagram of an identification information management table;

FIG. 11 is a diagram of an identification candidate information table;

FIG. 12 is a diagram of a reference biometric information table;

FIG. 13 is a flowchart of a procedure of authentication processing according to a third embodiment;

FIG. 14 is a diagram of hardware configuration of an authenticating apparatus according to a fourth embodiment;

FIG. 15 is a diagram of a PC in which the authenticating apparatus is disposed; and

FIG. 16 is a diagram of a portable device having the authenticating apparatus disposed therein.

### DESCRIPTION OF EMBODIMENTS

The present invention includes a biometric information input means (unit), a registered information memory means (unit), an identification candidate information memory means (unit) that memorizes candidate information, an identifying means (unit), etc., with respect to authentication based on biometric information of whether a user is a registrant and, by comparing input biometric information and registered biometric information, deciding on a single registrant or selecting plural registrants based on similarity and, when plural registrants are selected, memorizing these registrants as pieces of candidate information and limiting these pieces of the candidate information as objects to be identified for the biometric information to be input next time, realizes a shorter time for authentication processing and high-accuracy identity determination, even if plural candidates are produced for the input biometric information of the user. That is to say, at the time of the 1-to-N identification in the biometric authentication, when the user may not uniquely be identified by one time of inputting, candidates having high possibility of being the presenter of the biometric information is narrowed down and the time for and accuracy of subsequent identification is improved.

In each embodiment, it may be so arranged that the biometric information presented by the user undergoes signal processing by a signal processing means (unit) of a biometric information input unit, an authentication control unit, or the like, to be described later and is converted to characteristic data suitable for checking algorithm of the biometric authentication and the converted data is treated as the biometric information inside an apparatus. The information to be used as the biometric information in the fingerprint authentication may be image pattern information, minutia information, frequency information, etc.

### First Embodiment

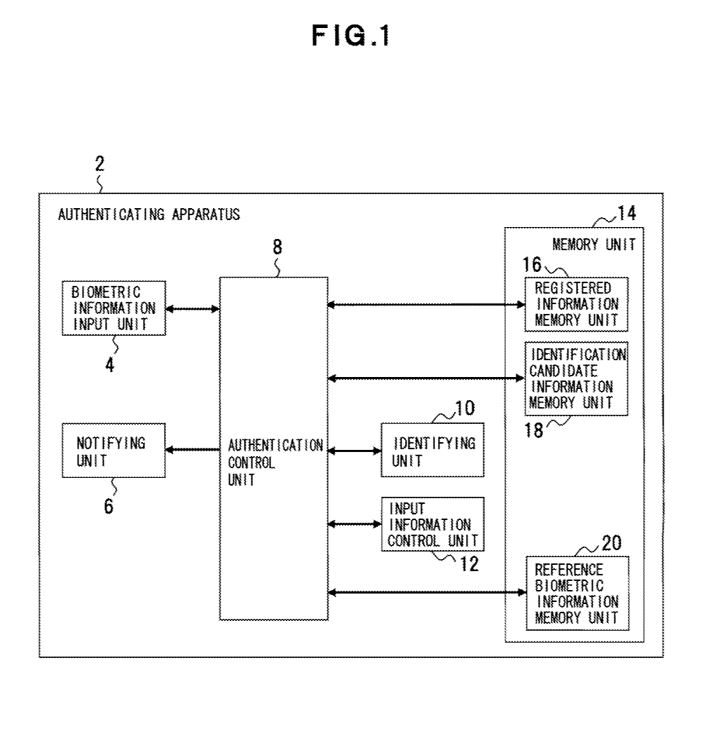

A first embodiment is described with reference to FIG. 1. FIG. 1 is a block diagram of an authenticating apparatus according to the first embodiment. The configuration depicted in FIG. 1 is one example and the present invention is not limited to such a configuration.

An authenticating apparatus 2 is one example of the apparatus to perform the biometric authentication of the 1-to-N system. Biometric information used for the authenticating apparatus 2 may mainly be a fingerprint, a face, a vein, an iris, a voice, etc., the information by other attributes may also be used. Biometric information is not limited to the fingerprint.

The authenticating apparatus 2 includes, as depicted in FIG. 1, a biometric information input unit 4, a notifying unit 6, an authentication control unit 8, an identifying unit 10, an input information control unit 12, and a memory unit 14.

The biometric information input unit 4 is a processing unit as an input means (unit) of inputting biometric information presented by a user and may be composed of, for example, a fingerprint sensor, a vein sensor, etc.

The notifying unit 6 is a processing unit as a means (unit) of notifying a user, etc., who seeks the identity determination from the authenticating apparatus 2 of various pieces of information and may be composed of, for example, a liquid crystal display device, information presenting screen thereof, etc. In this case, it may be so arranged that a notice of results of identity determination is given to an OS (Operating System) and other applications in the authenticating apparatus 2, or other devices by way of a network, etc. in addition to the authenticating apparatus 2 and that the notifying unit 6 is composed of such notifying system.

The authentication control unit 8 is an authenticating means (unit) of executing authentication processing, a control means (unit) corresponding to identification processing, and a memory control means (unit) of controlling at least one information memory unit in a memory means (unit) comprising information memory units described below and is a control unit as a means of controlling the biometric information input unit 4, the notifying unit 6, the identifying unit 10, the input information control unit 12, and the memory unit 14 to realize identity determination. Details of the control to be executed by the authentication control unit 8 are described in detail in a later description of a procedure representing a processing method or a processing program and are made clear by such description.

The identifying unit 10 is one example of an identifying means (unit) of identification processing and compares input data specified by the authentication control unit 8 with a registered information group of object to be identified in respect of the similarity, performs identity determination, and notifies the authentication control unit 8 of results thereof. In such processing, if the identity determination is not uniquely made and plural candidates are found, information of such candidates is notified to the authentication control unit 8.

The input information control unit 12 is a determining means (unit) of determining whether a user is a registrant by comparing the input biometric information with registered biometric information or reference biometric information and at the same time, is an information synthesizing means (unit) of synthesizing the input biometric information and the reference biometric information when both match (when the reference biometric information is identity information). Specifically, the input information control unit 12 compares biometric information input through the biometric information input unit 4 and reference biometric information memorized in a reference biometric information memory unit 20 and determines whether both pieces of information are input from the same user, based on the similarity. With respect to this determining method, the same method as used by the identifying unit 10 may be used or a different method may be used. In this case, a threshold or policy for determining whether to be the same input may have its conditions relaxed, as compared with an identifying threshold or policy for making identity determination. A reason thereof is that, even if it is erroneously determined that the input is the same, comparison is made only with the registered information group based on candidate information so far limited, and identity determination is not made, followed is execution of comparison processing with all the objects to be identified and comparison is made with true registered information of the user as well.

The memory unit 14 is a memory means (unit) of memorizing various pieces of information, includes, for example, a registered information memory unit 16, an identification candidate information memory unit 18 and the reference biometric information memory unit 20, and is composed of a recording medium such as a flash memory. The registered information memory unit 16 pre-stores user names and ID's of the users of the authenticating apparatus, related to the registered biometric information.

The identification candidate information memory unit 18 memorizes the candidate information obtained as a result of the identity determination processing at the identification unit 10.

The reference biometric information memory unit 20 memorizes the biometric information input from the biometric information input unit 4 or the biometric information synthesized at the input information control unit 12 as reference biometric information when identification candidate information is memorized as a result of the identity determination processing at the identifying unit 10. The memory unit 14 is not necessarily required to be configured integrally and for example, each of the identification candidate information memory unit 18 and the reference biometric information memory unit 20 may be composed of a volatile recording medium (e.g., RAM, etc.) separately from the registered information memory unit 16. In this case, the identification candidate information memory unit 18 and the reference biometric information memory unit 20 may serve as a working area to be provided whenever necessary to execute processing of the authenticating apparatus 2 to be described later.

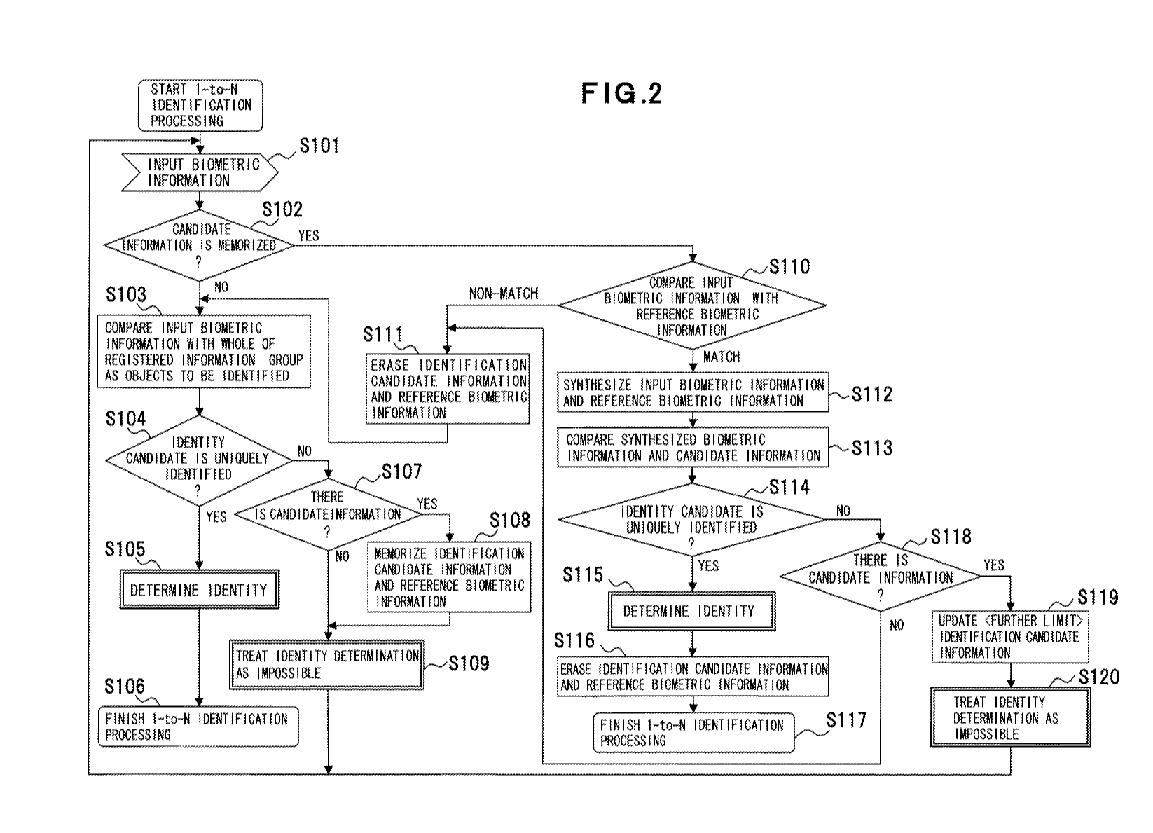

A process of the authenticating apparatus 2 is described with reference to FIG. 2. FIG. 2 is a flowchart of a procedure of the biometric authentication 1-to-N identification processing of the authenticating apparatus. The configuration depicted in FIG. 2 is one example and the present invention is not limited to such a configuration.

This procedure represents 1-to-N identification processing and is executed when a user inputs the biometric information to the authenticating apparatus 2 and seeks identity determination. This procedure is one example of an authenticating method or an authenticating program. As depicted in FIG. 2, biometric information is inputted (step S101) and whether candidate information is memorized is determined (step S102). If the candidate information is not memorized (step S102: No), then the input biometric information is compared with a whole of a registered information group as objects to be identified (step S103) and whether an identity candidate is uniquely identified is determined (step S104). If the identity candidate is uniquely identified (step S104: Yes), then the identity is determined (step S105) and the 1-to-N identification processing is finished (step S106).

If, at step S104, the identity candidate is not uniquely identified (step S104: No), then whether there is candidate information is determined (step S107). If there is the candidate information (step S107: Yes), then the identification candidate information and the reference biometric information are memorized (step S108). Then the identity determination is treated as impossible (step S109) and the procedure goes back to step S101. If there is no candidate information (step S107: No), then the identity determination is treated as impossible (step S109) and the procedure goes back to step S101.

If, at step S102, if the candidate information is memorized (step S102: Yes), then the input biometric information is compared with the reference biometric information which the previously input biometric information is regarded as, and which is memorized in the reference biometric information memory unit 20 (step S110). If both are non-match, then the identification candidate information and the reference biometric information are erased (step S111) and the procedure goes to step S103. If the input biometric information and the reference biometric information match, then the input biometric information and the reference biometric information are synthesized at the input information control unit 12 (step S112), the synthesized biometric information and the candidate information are compared (step S113), and whether the identity candidate is uniquely identified is determined (step S114). If the identity candidate is uniquely identified (step S114: Yes), then the identity is determined (step S115), the identification candidate information and the reference biometric information are erased (step S116), and the 1-to-N identification processing is finished (step S117).

If the identity candidate is not uniquely identified (step S114: No), then whether there is the candidate information is determined (step S118). If there is no candidate information (step S118: No), then the procedure goes to step S111. If there is the candidate information (step S118: Yes), then the identification candidate information is updated (further limited) (step S119), the identity determination is treated as impossible (step S120), and the procedure goes back to step S101.

In such procedure, a procedure is described of a case in which, after the identity is not uniquely identified but plural pieces of candidate information are obtained in the identification processing based on a first-time input from a user of the authenticating apparatus 2, the identity determination succeeds in the successive identification processing based on a second-time input from the same user, together with a function of each unit.

The authentication control unit 8 firstly causes the biometric information input unit 4 to input the biometric information (first-time input). The authentication control unit 8 determines whether the candidate information is memorized in the identification candidate information memory unit 18. Since the candidate information is not memorized in the identification candidate information memory unit 18 at the time of the first input, the authentication control unit 8 causes the identifying unit 10 to execute the identification processing between the input biometric information and the registered information group not limited as the objects to be identified.

The identifying unit 10 performs similarity comparison between the input biometric information and each piece of registered information and identifies an identity candidate. In this case, even if the identity candidate is not uniquely identified, the identifying unit 10 notifies the authentication control unit 8 of the candidate information when the registered information can be limited to plural identity candidates.

Upon receipt of the candidate information, the authentication control unit 8 memorizes the information in the identification candidate information memory unit 18 and memorizes the input biometric information in the reference biometric information memory unit 20 in preparation for use at the subsequent identification time and causes the notifying unit 6 to notify results of determination to the effect that the identity is not determined.

The authentication control unit 8 then causes the biometric information input unit 4 to input the biometric information (second-time input). The authentication control unit 8 determines whether the candidate information is memorized in the identification candidate information memory unit 18. Since the candidate information is memorized in the identification candidate information memory unit 18 at the time of the first-time input, the authentication control unit 8 causes the input information control unit 12 to execute the comparison between the input biometric information and the reference biometric information memorized in the reference biometric information memory unit 20.

In the case of determining that the input biometric information and the reference biometric information match, the input information control unit 12 combines these two pieces of information to generate the synthesized biometric information. The authentication control unit 8 causes the identifying unit 10 to execute the identification processing between the synthesized biometric information and the registered information group as the objects to be identified, limited by the candidate information.

The identifying unit 10 performs the similarity comparison between the synthesized biometric information and each piece of the registered information and identifies the identity candidate. Since the registered information to be compared here is limited information, there is the effect of shortening execution time. The comparison with the synthesized information including much of characteristic information enables obtaining the similarity at higher accuracy than the comparison with non-synthesized biometric information and heightening the possibility of the identity determination. When the identity candidate is uniquely identified, the identifying unit 10 notifies the authentication control unit 8 of the information capable of identifying such piece of the registered information by which the identity is determined.

The authentication control unit 8 causes the notifying unit 6 to notify the results of the determination to the effect that the identity is determined, erases the candidate information memorized in the identification candidate information memory unit 18 and the reference biometric information memorized in the reference biometric information memory unit 20, and finishes the 1-to-N identification processing. The notification in the case of the identity being determined is performed, for example, by displaying on a display screen to the effect that the identity is determined or by transmitting an ID (IDentification) of the candidate whose identity is determined to another device.

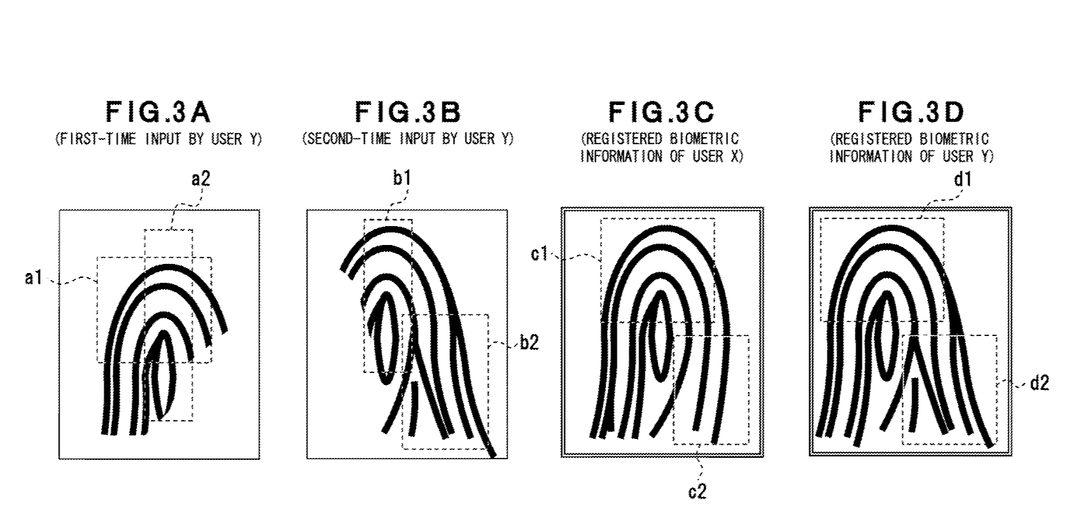

The comparison between the input biometric information and the registered information that the comparison is performed without synthesizing the biometric information is described with reference to FIGS. 3A to 3D. FIGS. 3A to 3D are diagrams of one example of the biometric information to be input and the registered information to be identified. The configuration depicted in FIGS. 3A to 3D is one example and the present invention is not limited to such a configuration.

These biometric information and registered information are specific examples of the biometric information not using the synthesized biometric information. FIG. 3A is a diagram of the biometric information according to the first-time input by a user Y; FIG. 3B is a diagram of the biometric information according to the second-time input by the user Y; FIG. 3C is a diagram of the registered biometric information of a user X; and FIG. 3D is a diagram of the registered biometric information of the user Y. It is assumed that there are many users other than the users X and Y. In such case, it is assumed that data of many other users do not represent high similarity when compared with the biometric information of the user Y. While a fingerprint image is used as the biometric information in this embodiment, the biometric information may be other than the fingerprint image.

The first-time input (FIG. 3A) is taken as the input biometric information and the identification processing is executed between this input biometric information and the registered information group as whole objects to be identified. Since, as a result of the identity determination, an area a1 of FIG. 3A represents high similarity to an area c1 of FIG. 3C and an area d1 of FIG. 3D, the users X and Y are memorized in the identification candidate information memory unit 18 as the identification candidate information and the biometric information (FIG. 3A) is memorized in the reference biometric information memory unit 20 as the reference biometric information.

In this situation, the second-time input (FIG. 3B) is made. The input information control unit 12 performs comparison between the second-time input (FIG. 3B) and the reference biometric information (FIG. 3A) memorized in the reference biometric information memory unit 20, determines that these two inputs are from the same user in light of high similarity between an area a2 of FIG. 3A and an area b1 of FIG. 3B, and executes the identification between the biometric information depicted in FIG. 3B and only the objects to be identified, limited by the first-time input (FIGS. 3C and 3D).

In this identification processing, since an area b2 of FIG. 3B is different from an area c2 of the biometric information of FIG. 3C and represents high similarity to an area d2 of the registered biometric information of FIG. 3D and since other parts than the area b2 of FIG. 3B also represents high similarity to the registered biometric information depicted in FIG. 3D, the identity may be determined as the user Y.

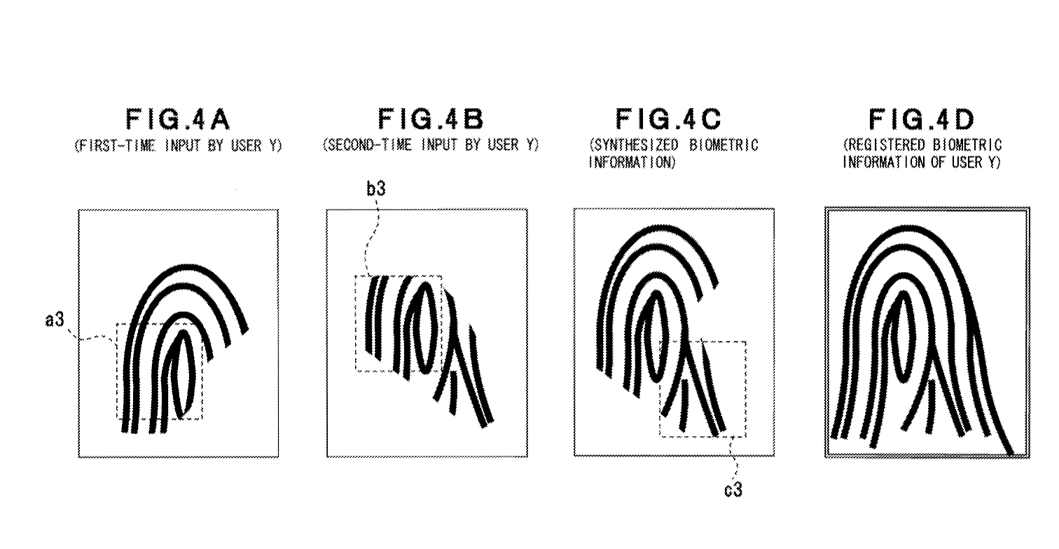

The comparison between the input biometric information and the registered information with synthesizing the biometric information is described with reference to FIGS. 4A to 4D. FIGS. 4A to 4D are diagrams of one example of the biometric information to be input and the synthesized biometric information. The configuration depicted in FIGS. 4A to 4C is one example and the present invention is not limited to such a configuration.

FIG. 4A is the first-time input by the user Y. The first-time input and the results of the identification (the users X and Y are identity candidates) are the same as in the case of FIGS. 3A to 3D earlier described.

In this case as well, the second-time input (FIG. 4B) is made. The input information control unit 12 performs comparison between the second-time input (FIG. 4B) and the reference biometric information (FIG. 4A) memorized in the reference biometric information memory unit 20 and determines that these two inputs are from the same user in light of high similarity between an area a3 of the reference biometric information (FIG. 4A) and an area b3 of the biometric information (FIG. 4B).

The input information control unit 12 synthesizes the reference biometric information depicted in FIG. 4A and the biometric information depicted in FIG. 4B on the basis of matching relationship between the area a3 and the area b3 and obtains the synthesized biometric information as depicted in FIG. 4C. The authentication control unit 8 specifies only the registered information of the users X and Y limited by the first-time input as the objects to be identified and instructs the identifying unit to execute the identification processing with the synthesized biometric information (FIG. 4C). In this identification processing, the synthesized biometric information (FIG. 4C), which, as depicted in FIG. 4C, has the newly obtained information of an area c3 in addition to the reference biometric information depicted in FIG. 4A, represents high similarity only to the registered information of the user Y (FIG. 4D) and the identity of the user Y may correctly be determined. In the situation where the total volume of the information is small as depicted in the second-time input (FIG. 4B) in the present example, or in the situation where the biometric information by the second-time input and the registered information largely deviate from each other in respect of the acquisition area, since it is expected that the similarity comparison between the biometric information depicted in FIG. 4B, rather than the synthesized biometric information (FIG. 4C), and the registered information of the user Y does not produce the similarity sufficient to make the identity determination and results in false rejection, the effect by synthesizing is great for avoiding such inconveniences.

While the fingerprint image is used as the biometric information in the present embodiment, the present invention is not limited to the fingerprint but may be applied to the biometric information of other attributes, as earlier described.

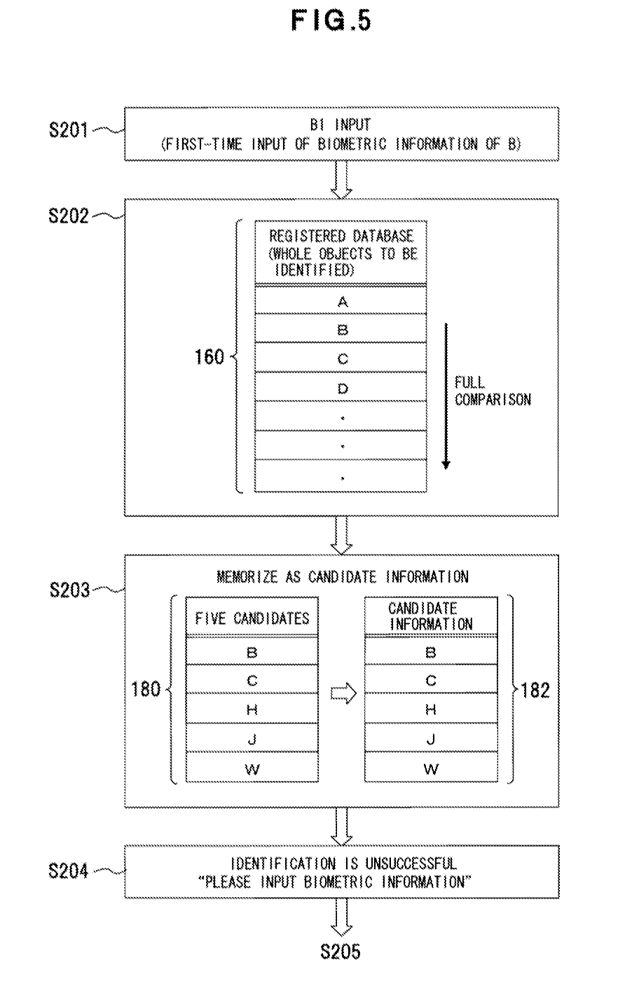

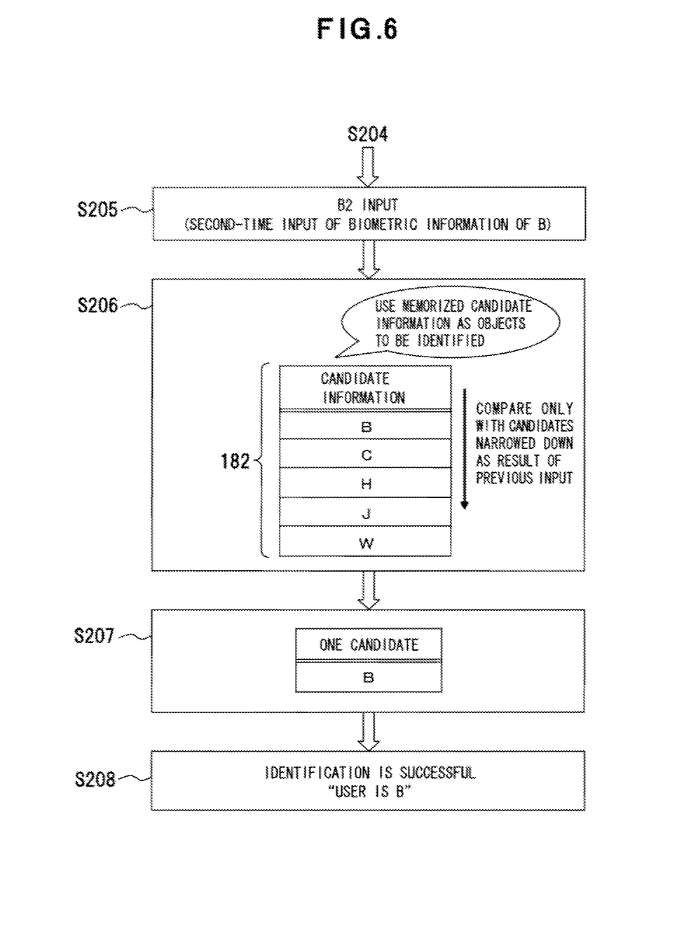

The identification processing using the narrowing-down is described with reference to FIGS. 5 and 6. FIGS. 5 and 6 are flowcharts of a procedure of the identification processing using the narrowing-down. The configuration depicted in FIGS. 5 and 6 is one example and the present invention is not limited to such a configuration.

This procedure is one example of the authenticating method or the authenticating program and, from input biometric information (B1, B2, etc.), image pattern information, minutia information, frequency information, etc., are extracted as characteristic information and are compared with biometric characteristics of registered templates (A, B, C, D, . . . ). In this procedure, as depicted in FIG. 5, a B1 input is made (step S201) and at step S201, this is a first-time input of the biometric information of B. A full comparison is made between this biometric information (B1 input) and the registered templates A, B, C, D, . . . present in a registered database 160 of the registered information memory unit 16 (step S202). That is to say, the input biometric information is compared with all pieces of the biometric information present in the registered database 160 as the objects to be identified.

As a result of this comparison, for example, five candidates B, C, H, J, and W are extracted as candidates of high similarity (step S203). This candidate list 180 is memorized in the identification candidate information memory unit 18 as candidate information 182.

When the identity is not determined from these candidates, the identification is unsuccessful and in such case, the notifying unit 6 issues a message “Please input biometric information”, prompting a second-time input (B2 input) of the biometric information (step S204).

Then, the B2 input is made (step S205). At step S205, this is the second-time input of the biometric information of B.

With respect to the second-time input biometric information, pieces of the candidate information 182 memorized in the identification candidate information memory unit 18 are used as the objects to be identified and this second-time biometric information is compared with the candidates narrowed down as a result of the previous input, namely, five candidates B, C, H, J, and W in this case (step S206). This comparison processing is performed only with the narrowed-down candidates B, C, H, J, and W.

As a result of this comparison, one candidate is identified on the basis of the similarity (step S207). In the present embodiment, the candidate B is identified. As a result, the identification is successful (step S208), the fact that “the user is B” is notified through the notifying unit 6 and this processing is finished.

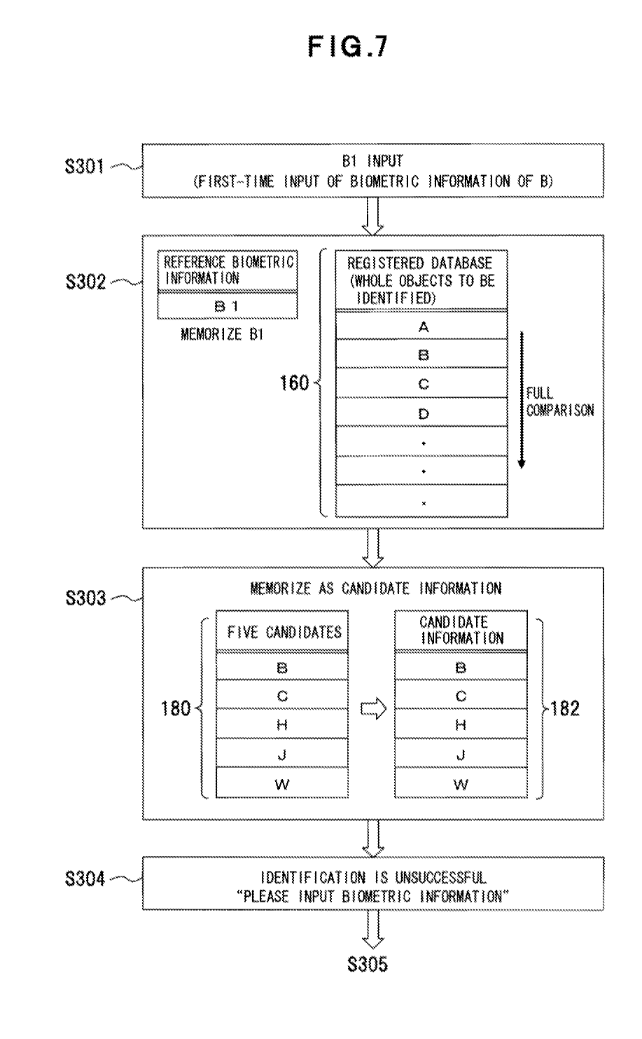

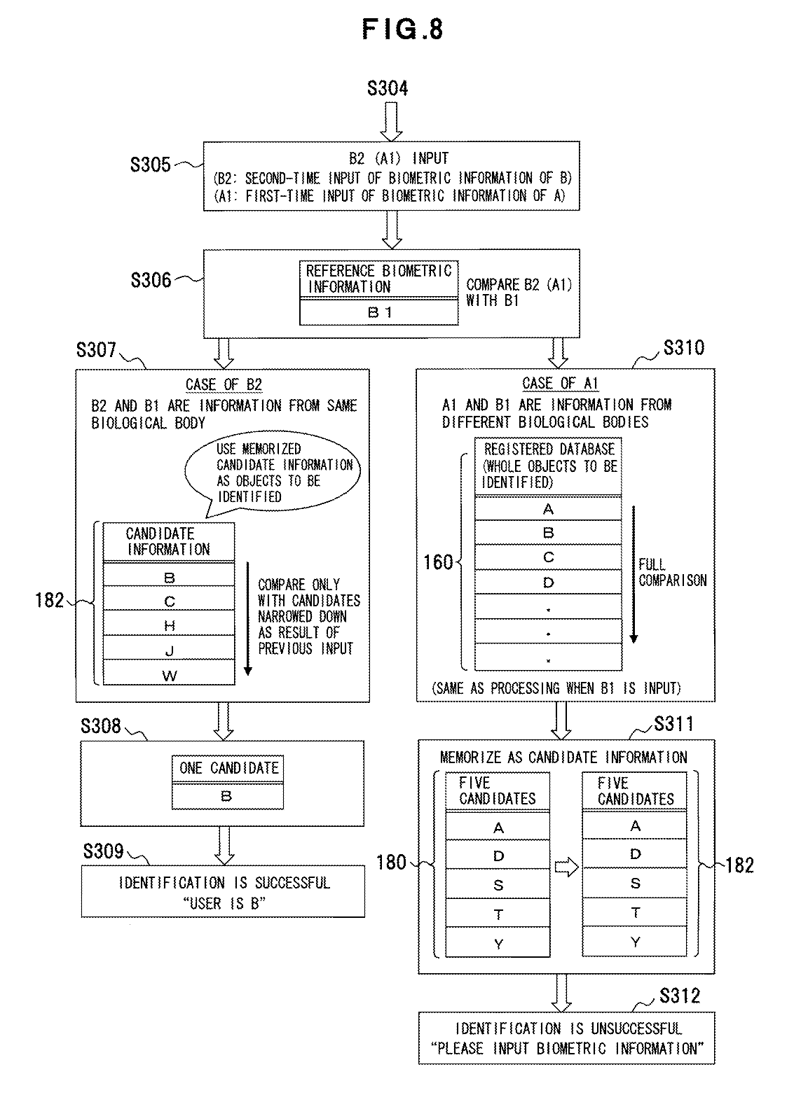

Authentication processing using other narrowing-down processing is described with reference to FIGS. 7 and 8. FIGS. 7 and 8 are flowcharts of a procedure of other identification processing using the narrowing-down. The configuration depicted in FIGS. 7 and 8 is one example and the present invention is not limited to such a configuration.

This procedure is one example of the authenticating method or the authenticating program and, from the input biometric information (B1, B2, etc.), the image pattern information, the minutia information, the frequency information, etc., are extracted as the characteristic information and are compared with the biometric characteristics of the registered templates (A, B, C, D, . . . ). The authenticating apparatus 2 (FIG. 1) is used as a processing apparatus.

In this procedure, as depicted in FIG. 7, B1 input is made (step S301) and at step S301, this is a first-time input of the biometric information of B. A full comparison is made between this biometric information (B1 input) and the registered templates A, B, C, D, . . . present in the registered database 160 of the registered information memory unit 16 (step S302). That is to say, the input biometric information is compared with all pieces of the biometric information present in the registered database 160 as the objects to be identified. At this moment, the biometric information of the B1 input is memorized in the reference biometric information memory unit 20 as the reference biometric information B1.

As a result of the comparison at step S302, for example, five candidates B, C, H, J, and W are extracted as candidates of high similarity (step S303). This candidate list 180 is memorized in the identification candidate information memory unit 18 as the candidate information 182.

When the identity is not determined from these candidates, the identification is unsuccessful. In such case, the notifying unit 6 issues a message “Please input biometric information”, prompting a second-time input (B2 input) of the biometric information (step S304).

Then, the input of B2 and A1 is made (step S305). At step S205, B2 is the second-time input of the biometric information of B and A1 is the first-time input of the biometric information of A.

These pieces of the biometric information B2 (A1) are compared with the reference biometric information B1 memorized in the reference biometric information memory unit 20 (step S306).

In the case of the biometric information B2, since the biometric information B2 and the reference biometric information B1 are information from the same biological body, pieces of the candidate information 182 memorized in the identification candidate information memory unit 18 are used as the objects to be identified and are compared with the biometric information B2 in the same manner as in the procedure earlier described (step S307). That is to say, the comparison processing is performed only with the narrowed-down candidates B, C, H, J, and W.

As a result of this comparison, one candidate is identified on the basis of the similarity (step S308) and in the present embodiment, the candidate B is identified. As a result, the identification is successful (step S309), the fact that “the user is B” is notified through the notifying unit 6 and this processing is finished.

In the comparison at step S306, in the case of the biometric information A1, since the biometric information A1 and the biometric information B1 are information from different biological bodis, a full comparison is made between this biometric information (A1 input) and the registered templates A, B, C, D, . . . present in the registered database 160 of the registered information memory unit 16 (step S310). That is to say, the input biometric information is compared with all pieces of the biometric information present in the registered database 160 as the objects to be identified.

As a result of the comparison at step S310, for example, five candidates A, D, S, T, and Y are extracted as candidates of high similarity (step S311). This candidate list 180 is memorized in the identification candidate information memory unit 18 as the candidate information 182.

When the identity is not determined from these candidates, the identification is unsuccessful and in such case, the notifying unit 6 issues a message “Please input biometric information”, prompting a second-time input of the biometric information (step S312).

With respect to the authenticating processing, the authenticating method, or the authenticating program according to the first embodiment described above, characteristic matters, effects, etc., are extracted and enumerated below.

(1) Even if plural candidates are produced for input biometric information of a user, since biometric information to be input next time is compared with such narrowed-down candidates, a shorter time of the authenticating processing and high-accuracy identity determination can be realized.

(2) In the 1-to-N identification, when false rejection occurs due to a poor input condition, etc., limiting registered information as objects to be identified at the time of second-time or subsequent input, using first-time identification information, enables shortening authenticating time in total.

(3) When identify candidates are further limited at the time of the second-time or subsequent input, treating the further limited registered information as the objects to be identified at the time of the next and subsequent identification enables further shortening the authenticating time.

(4) By confirming before the identification whether the biometric information by the second-time or subsequent input and the biometric information at the time of the first-time input when the candidate information is memorized to be used for limiting the objects to be identified come from the same user, the problem can be prevented from occurring that when the user changes to another person, the authentication is performed to inappropriately limited objects to be identified and a different identity is erroneously determined. Since this is the identification with the registered information of the user oneself excluded from the objects to be identified and accordingly, there is no possibility that the identity of the user oneself is determined and since such identification is highly risky as compared with the ordinary 1-to-N authentication, prevention of this problem is highly effective.

(5) By automatically recognizing the change of the presented biometric information between the first-time input and the second-time or subsequent input even if the user changes to a different user at the time of inputting with the objects to be identified being limited and performing the identification to the non-limited registered information group, appropriate authenticating processing can be performed for the identity determination of a new user without performing an unnecessarily large number of inputs or special operations.

(6) By synthesizing plural pieces of the biometric information by plural times of inputting from the same user, the synthesized information may possibly be obtained that contains the characteristic information than the single information and in such case, the synthesized information enables obtaining the similarity with accuracy higher than that of non-synthesized information and enhancing the probability of correctly determining the identity.

(7) Even if the identification error is involved in results of the identification by the first-time input and the registered information of the user is not included in the candidate information to be used for limiting the objects to be identified, by performing the identification with a whole of the registered information group before the limitation when, at the time of the second-time or subsequent input, after making the input with the objects to be identified being limited, no identity candidate is found, the identity determination can be made even if the limiting is unsuccessful.

### Second Embodiment

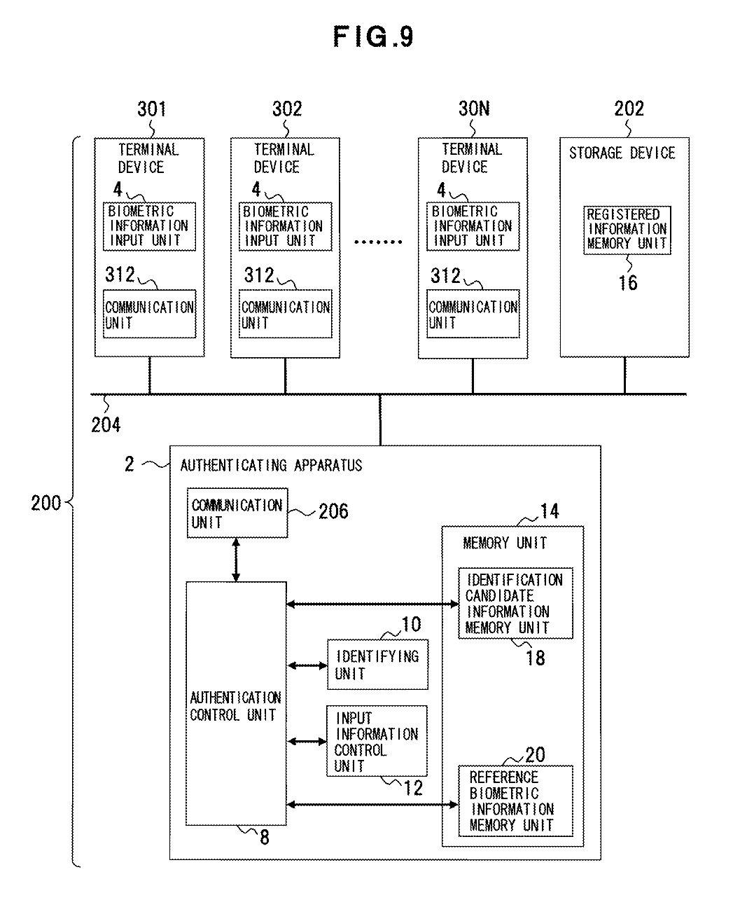

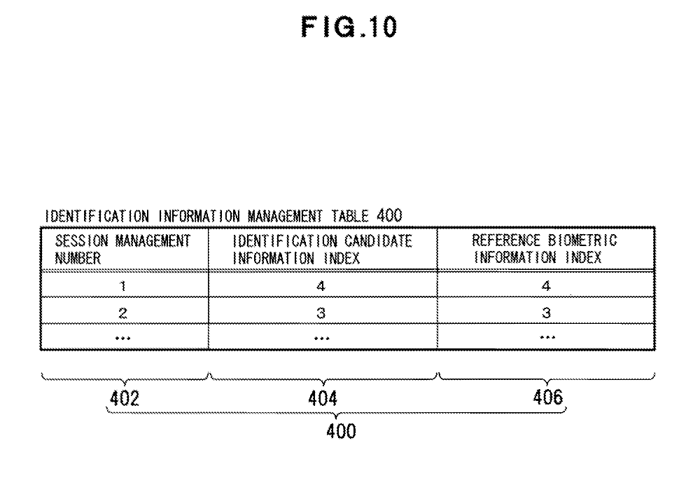

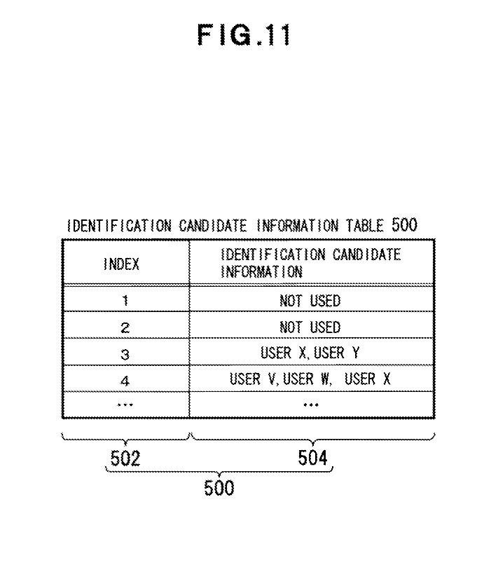

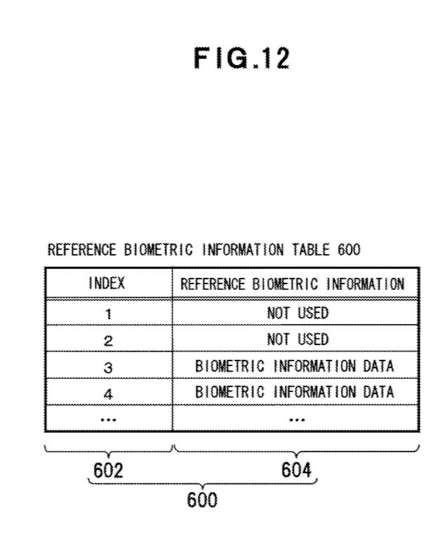

A second embodiment is described with reference to FIGS. 9 to 12. FIG. 9 is a block diagram of a configuration example of an authenticating system according to the second embodiment; FIG. 10 is a diagram of an identification information management table; FIG. 11 is a diagram of an identification candidate information table; and FIG. 12 is a diagram of a reference biometric information table. The configuration depicted in FIGS. 9 to 12 is one example and the present invention is not limited to such a configuration. In FIG. 9, the same parts as in FIG. 1 are given the same reference numerals.

This authenticating system 200 is configured by using the authenticating apparatus 2 earlier described, one or more information processing terminal devices, and an external storage device. That is to say, this authenticating system 200 has the authenticating apparatus 2 (FIG. 1) from which the registered information memory unit 16 is excluded, a storage device 202, and plural terminal devices 301, 302, . . . 30N, all of them being interconnected by a network 204.

The authenticating apparatus 2 includes the authentication control unit 8, the identifying unit 10, the input information control unit 12, a communication unit 206, and a memory unit 14. The memory unit 14 includes the identification candidate information memory unit 18 and the reference biometric information memory unit 20 and differs from the memory unit of FIG. 1 in that the registered information memory unit 16 is shifted to the storage device 202. The communication unit 206 is a means (unit) of communicating with the external information processing terminal devices and communication medium may be either wired or wireless. Other part of the authenticating apparatus 2, which is of the same configuration as in the authenticating apparatus 2 earlier described (FIG. 1), is given the same reference numeral and description thereof is omitted.

Each of the terminal devices 301 to 30N is one example of one or more information processing terminal devices tied up with the authenticating apparatus 2 by wire or wireless and may not only be of plural configuration but also be of single configuration. Each of the terminal devices 301 to 30N includes the biometric information input unit 4 and a communication unit 312. The biometric information input unit 4 is the same as the biometric information input unit 4 earlier described (FIG. 1) and is used as a means (unit) of inputting fingerprint, etc., as biometric information of a user from the terminal devices 301 to 30N. The communication unit 312 is a means (unit) of communicating with the communication unit 206 earlier described.

The storage device 202 is provided with the above described registered information memory unit 16, is connected with the authenticating apparatus 2 by way of the network 204, and provides the registered biometric information in authenticating. The network 204 is preferably configured to communicably connect the registered information memory unit 16 and the storage device 202 and to prevent each of the terminal devices 301 to 30N and the storage device 202 from directly communicating with each other. This storage device 202 may be configured integrally with the authenticating apparatus 2.

In this authenticating system 200, the biometric information input by the biometric information input unit 4 of any one of the terminal devices 301 to 30N is conveyed to the authentication control unit 8 of the authenticating apparatus 2 by executing authentication request processing, using the communication unit 312 of one of the terminal devices 301 to 30N that needs the authentication and the communication unit 206 of the authenticating apparatus 2.

The authentication control unit 8 distinguishes, through communication session, by each of the terminal devices 301 to 30N, whether an authenticating request is issued from the biometric information input unit 4 of each of the terminal devices 301 to 30N. Other than this, the authentication request may be distinguished by each terminal device according to the requesting device number included in an authentication request processing message and a system in which plural authentication requests are simultaneously made from one terminal device may adopt a method of distinguishing according to the requesting device number and a flow number. As seen above, there is no limitation in particular as to the method of distinguishing a source of the input of the biometric information.

While 1-to-N identification procedure inside the authenticating apparatus 2 is the same as in the first embodiment, the identification candidate information and the reference biometric information are kept by source of input of the biometric information and are managed by an identification information management table 400 (FIG. 10). As depicted in FIG. 10, this identification information management table 400 stores an identification candidate information index 404 and a reference biometric information index 406 corresponding to a session management number 402, and the identification candidate information and the reference biometric information are distinguished by communication session.

In relation to this identification information management table 400, an identification candidate information table 500 (FIG. 11) is established in the identification candidate information memory unit 18 and a reference biometric information table 600 (FIG. 12) is established in the reference biometric information memory unit 20. As depicted in FIG. 11, the identification candidate information table 500 stores identification candidate information 504 in correspondence to an index 502. As depicted in FIG. 12, a reference biometric information table 600 stores reference biometric information 604 in correspondence to an index 602. Accordingly, if index information is given, candidate information data and the biometric information data are read out.

In place of the management on this identification information management table 400, it may be so arranged that the identification candidate information memory unit 18 and the reference biometric information memory unit 20 are integrated to make up such an information memory means (unit) that is capable of keeping both pieces of data by communication session.

The authenticating system of such a configuration enables judging by comparing the biometric information input from the terminal device with the registered biometric information using the storage device and the authenticating apparatus disposed separately from the terminal device, performing the identification based on the similarity, and performing the identity authentication. The characteristic matters and advantages already described in the first embodiment are likewise applicable to such authenticating system.

### Third Embodiment

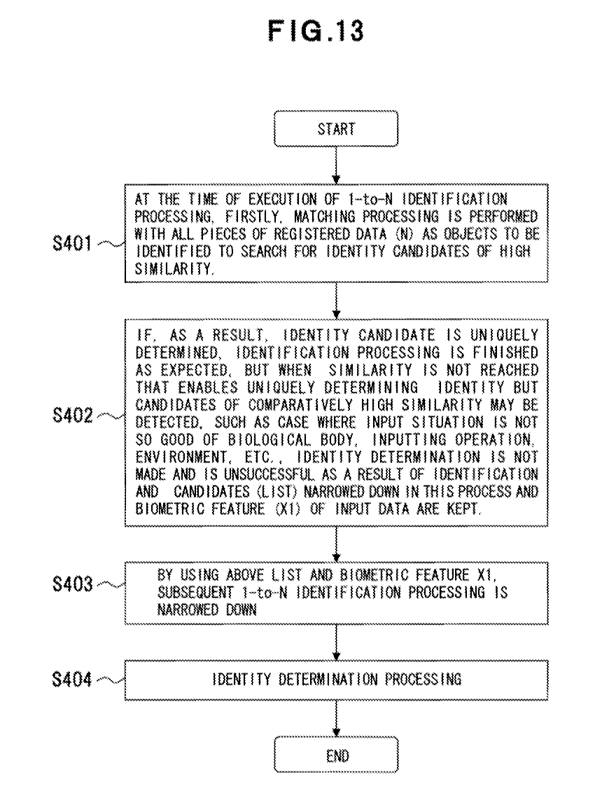

A third embodiment is described with reference to FIG. 13. FIG. 13 is a flowchart of a procedure of authentication processing according to the third embodiment. The configuration depicted in FIG. 13 is one example and the present invention is not limited to such a configuration.

The procedure according to the third embodiment is as follows:

(1) At the time of execution of 1-to-N identification processing, firstly, matching processing is performed with all pieces of registered data N as objects to be identified to search for identity candidates of high similarity (step S401).

(2) If, as a result, the identity candidate is uniquely determined, the identification processing is finished as expected. However, when the similarity is not reached that enables uniquely determining the identity but candidates of comparatively high similarity may be detected, such as the case where an input situation is not so good of a biological body, an inputting operation, an environment, etc., the identity determination is not made and is unsuccessful as a result of the identification, and the candidates (LIST) narrowed down in this process and biometric feature X1 of the input data are kept (step S402).

(3) By using the above LIST and biometric feature X1, the subsequent 1-to-N identification processing is narrowed down (step S403).

(4) Based on the narrowing-down of the information, the authentication processing is executed as the identity determination processing (step S404).

In such processing, a user whose identity is not determined usually follows up with retrial of inputting the same biometric data. When biometric feature X2 of the input data and the biometric feature X1 kept at step S402 are compared and these pieces of input data are determined to be from the same biological body, the processing is performed of matching the biometric feature X2 of the retried input with only the candidates narrowed down at the time of the first-time identification (LIST) and the identity is determined, thereby decreasing the total checking time. If, in place of the retried input biometric feature X2, the data (X1 and X2) obtained by synthesizing the biometric features X1 and X2 is used as the input biometric feature, such a configuration may increase characteristic information.

Comparing X1 and X2 at the time of inputting prevents worsening of the identification accuracy by erroneous narrowing-down in the case of input change from one user to another in the course of a sequence of identification processing. In this case, matching is be performed with the whole registered data (N), without performing the narrowing-down based on first results.

In a system of the 1-to-N identification method, when false rejection occurs due to poor input condition, etc., narrowing down the registered data as the objects to be identified for the second-time or subsequent identification, using the first-time identification information, enables considerably shortening the 1-to-N identification time. In such case, increasing the characteristic information by synthesizing data so far obtained from plural times of input and performing processing of matching such synthesized input data with candidate data enable enhancing an identity acceptance rate.

A conceivable, representative example of such authenticating apparatus is the 1-to-N identification in BIOS fingerprint authentication in a notebook PC (personal computer). In view of the fact that as to fingerprint authentication processing under the BIOS, importance is attached to identification speed due to limitation of CPU calculating speed and that an inputting source is limited to a sensor incorporated in a notebook PC, this system is expected to be particularly effective that achieves speed improvement for consecutive inputs of biometric data from the same presenter of a biological body. This authenticating apparatus, authenticating method, or authenticating program may also be applied to a server authentication model. In the case of performing the 1-to-N identification on a server, a mechanism may be added by which the inputs from plural clients are related to sessions for distinguishing such inputs and plural input biometric features and pieces of the candidate data are kept, managed, and distinguished.

### Fourth Embodiment

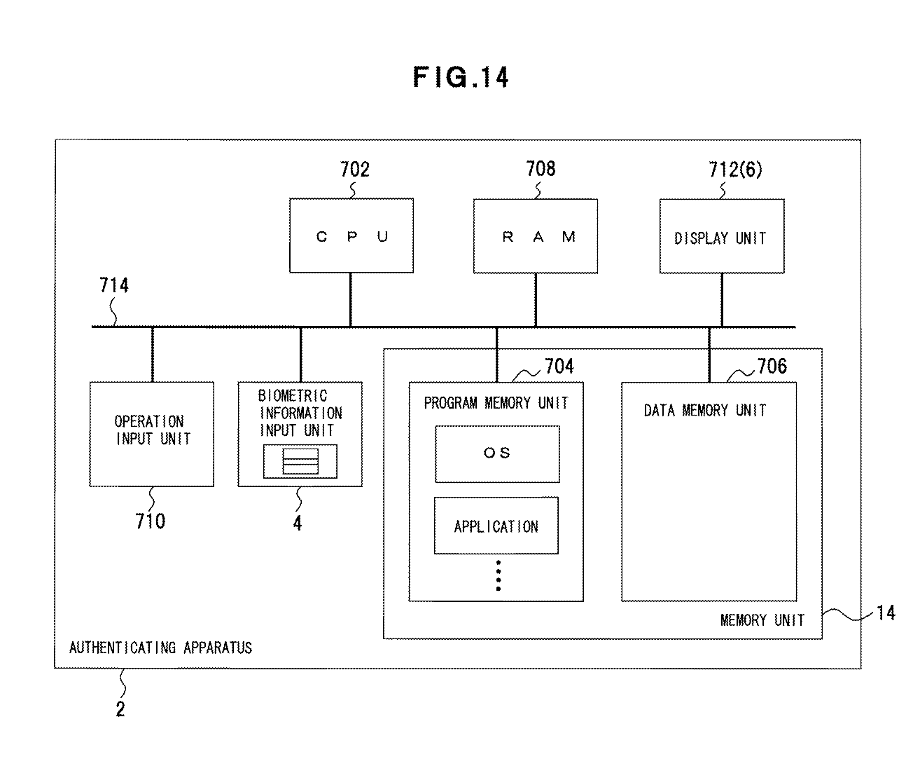

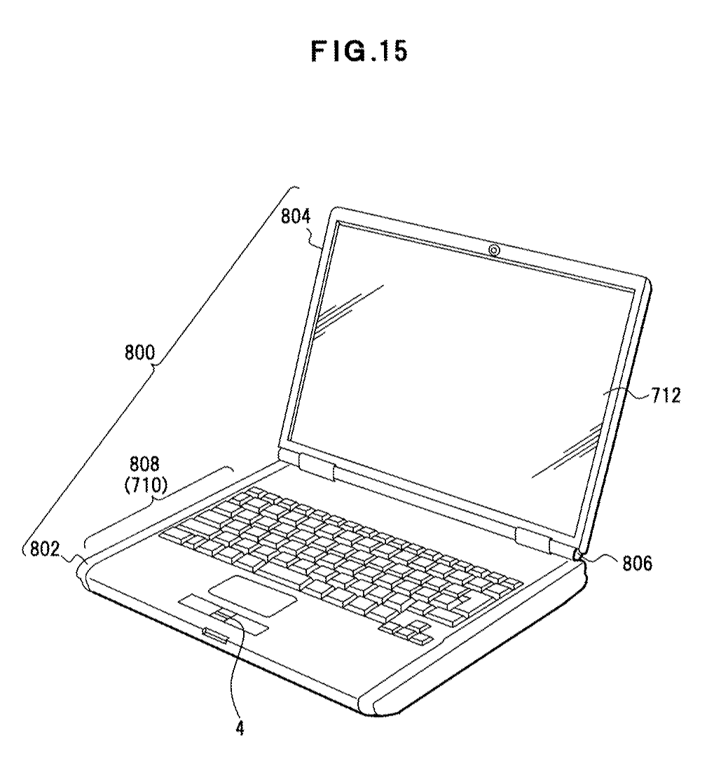

A fourth embodiment is described with reference to FIGS. 14 and 15. FIG. 14 is a diagram of hardware configuration of an authenticating apparatus; and FIG. 15 is a diagram of a personal computer (PC) in which an authenticating apparatus is disposed. The configuration depicted in FIGS. 14 and 15 is one example and the present invention is not limited to such a configuration. In FIGS. 14 and 15, the same parts as in FIG. 1 are given the same reference numerals.

This authenticating apparatus 2 (FIG. 14) is configured by including a computer as an information processing means (unit) of capturing input biometric information of a fingerprint, etc., and executing authentication processing and is provided with a CPU (Central Processing Unit) 702, a program memory unit 704, a data memory unit 706, a RAM (Random-Access Memory) 708, an operation input unit 710, a display unit 712, and the biometric information input unit 4, all of which are interconnected by a bus 714.

The CPU 702 is a control means (unit) of performing fingerprint image acquisition, feature extraction processing, matching processing, and other storage, calculation, etc., of various types of data by executing an OS (Operating System) and an application program such as an authenticating program and, together with the RAM 708, makes up the notifying unit 6, the authentication control unit 8, the identifying unit 10, the input information control unit 12, etc., earlier described.

The RAM 708 is a work area. The display unit 712 is an information presenting means (unit) and is composed of, for example, an LCD (Liquid Crystal Display). The operation input unit 710 is composed of a keyboard, etc.

The biometric information input unit 4 is composed of a fingerprint sensor, an imaging means (unit), etc., and is a means (unit) of capturing biometric information of a fingerprint, etc.

The program memory unit 704 is one example of a recording means (unit) of recording a program and is composed of a computer-readable and writable recording medium. This program memory unit 704 stores an OS and routines such as the already described biometric information authenticating program, etc., as an application program.

The data memory unit 706 is one example of a storage means (unit) of storing data and stores biometric information, etc. The data memory unit 706 may also be set to store necessary data according to the above embodiments.

This authenticating apparatus 2 is disposed, for example, in a PC 800 (FIG. 15). As depicted in FIG. 15, this PC 800 has a body 802 and a body 804 configured to be capable of opening and closing at a hinge part 806. The body 802 provides a keyboard 808 (one example of an input unit of the operation input unit 710) and provides, for example, a sweep fingerprint sensor as the biometric information input unit 4. A display unit 712 is disposed in the body 804.

According to such a configuration, speedy and highly reliable biometric authentication and identity authentication can be performed by the identification of input biometric information with registered biometric information or by the narrowing-down thereof, in the PC 800.

### Other Embodiment

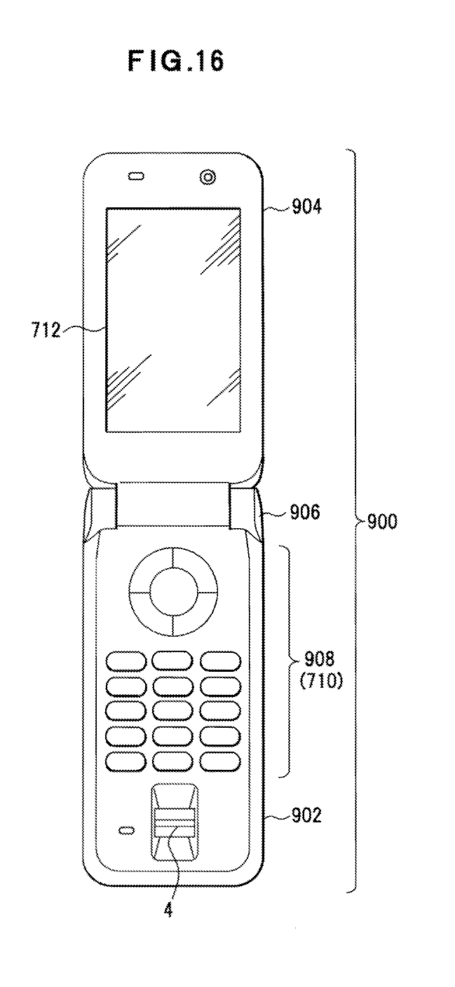

(1) While the PC 800 is exemplified in the above embodiment (FIG. 15), electronic equipment in which the authenticating apparatus 2 is disposed may be a portable device 900 (FIG. 16). As depicted in FIG. 16, this portable device 900 has a body 902 and a body 904 configured to be capable of opening and closing at a hinge unit 906. The body 902 provides a keyboard 908 (one example of an input unit of the operation input unit 710) and provides, for example, a sweep fingerprint sensor as the biometric information input unit 4. The display unit 712 is disposed in the body 904.

According to such a configuration, speedy and highly reliable biometric authentication and identity authentication can be performed by the identification of input biometric information with registered biometric information or by the narrowing-down thereof, in the portable device 900.

(2) While, in the above embodiment, the portable device 900 (FIG. 16) is exemplified as an installation example of a fingerprint authenticating apparatus in which a fingerprint image acquiring device is disposed, the authenticating apparatus may be disposed in a small information equipment such as a PDA (Personal Digital Assistant) or may be disposed in other electronic devices.

(3) The already described portable device 900 may be used in the terminal devices 301 to 30N or the authenticating apparatus 2 of the above embodiment (FIG. 9).

(4) Constituent elements, expressions, or arbitrary combinations of the constituent elements of the present invention already described, including those applied to a method, an apparatus, a system, a computer program, a recording medium, data structure, etc., are also effective as modes of the present invention.

Technological thoughts are then enumerated that are extracted from the embodiments of the present invention described above. The technological thoughts associated with the present invention, from superordinate concepts to subordinate concepts, may be grasped at various levels and in various variations and the present invention is not limited to the following description.

In the authenticating apparatus, preferably, the identifying unit may compare the biometric information to be input and the registered biometric information memorized in the identification candidate information memory unit as the candidate information and if, based on the similarity of both, plural registrants are extracted from the registered biometric information, updates the candidate information of the identification candidate information memory unit by the plural registrants as latest candidate information.

According to such a configuration, since the candidate information is updated to the latest one, the identification accuracy of high reliability is obtained and the above object is achieved by such a configuration as well.

According to such a configuration, when the identify candidates are further limited at the time of the second-time or subsequent input, treating the further limited registered information as the objects to be identified at the time of the next or subsequent identification enables further shortening the authenticating time.

The authenticating apparatus may preferably further include a reference biometric information memory unit to memorize the biometric information input from the biometric information input unit as reference biometric information, wherein the identifying unit compares the reference biometric information memorized in the reference biometric information memory unit and the biometric information input by the biometric information input unit and, if both are determined to be biometric information of the same user in view of similarity, uses the candidate information memorized in the identification candidate information memory unit as the objects to be identified. According to such a configuration as well, the problem can be prevented of performing the authentication to inappropriately limited objects to be identified and erroneously determining a different identity, when a user changes to another person.

According to such a configuration, by confirming before the identification whether the biometric information by the second-time or subsequent input and the biometric information at the time of the first-time input when the candidate information is memorized to be used for limiting the objects to be identified come from the same user, the problem can be prevented from occurring that when a user changes to another person, the authentication is performed to inappropriately limited objects to be identified and a different identity is erroneously determined. Since the identification is performed with the excluding registered information of the user oneself from the objects to be identified and accordingly, there is no possibility that the identity of the user oneself is determined and since such identification is highly risky as compared with the ordinary 1-to-N authentication, prevention of this problem is highly effective.

The authenticating apparatus may preferably further include a memory control unit in the identification candidate information memory unit and/or the reference biometric information memory unit, wherein the identifying unit compares the reference biometric information with the biometric information input by the biometric information input unit and, if both are determined not to be biometric information of the same user in view of the similarity, the memory control unit erases the candidate information from the identification candidate information memory unit and the reference biometric information from the reference biometric information memory unit, and the identifying unit uses the registered biometric information present in the registered information memory unit as the objects to be identified.

According to such a configuration, by automatically recognizing the change of the presented biometric information between the first-time input and the second-time or subsequent input even if a user changes to another user at the time of inputting with the objects to be identified being limited and performing the identification to the non-limited registered information group, appropriate authenticating processing may be performed for the identity determination of a new user without performing an unnecessarily large number of inputs or special operations.

The authenticating apparatus may preferably further include an information synthesizing unit to synthesize the biometric information input from the biometric information input unit and the reference biometric information stored in the reference biometric information memory unit, wherein the identifying unit, in a case of determining users to be the same, causes the information synthesizing unit to synthesize the input biometric information and the reference biometric information stored in the reference biometric information memory unit and uses the synthesized biometric information for identification.

According to such a configuration, by synthesizing plural pieces of biometric information by plural times of inputting from the same user, synthesized information may possibly be obtained that includes more characteristic information than single information and in such case, the synthesized information enables obtaining the similarity with accuracy higher than that of non-synthesized information and enhancing probability of correctly determining the identity.

In the authenticating apparatus, preferably, the identifying unit may perform identification using all pieces of the registered biometric information present in the registered information memory unit as objects to be identified for the biometric information to be input when, as a result of using the candidate information memorized in the identification candidate information memory unit as the objects to be identified, identity candidate is not identified from the candidate information.

According to such a configuration, even if an identification error is involved in results of the identification by the first-time input and registered information of a user is not included in candidate information to be used for limiting the objects to be identified, by performing the identification to a whole of the registered information group before the limitation when, at the time of the second-time or subsequent input, after making the input with the objects to be identified being limited, no identity candidate is found, the identity determination can be made even if the limiting is unsuccessful.

The authenticating apparatus may preferably further include a notifying unit to notify information representing the registrant who is decided and/or the registrants who is selected.

In the authenticating system, preferably, the authenticating apparatus may include an identification candidate information memory unit to memorize candidate information, and wherein the authenticating apparatus compares the biometric information input to the terminal device and the registered biometric information memorized in the identification candidate information memory unit and if, based on the similarity of both, plural registrants are extracted from the registered biometric information, updates the candidate information of the identification candidate information memory unit by the plural registrants as latest candidate information.

In the authenticating system, preferably, the authenticating apparatus may include a reference biometric information memory unit to memorize the biometric information input to the terminal device as reference biometric information, and wherein the authenticating apparatus may compare the reference biometric information memorized in the reference biometric information memory unit and the biometric information to be input and, if both are determined to be biometric information of the same user in view of similarity of both, may use the candidate information memorized in the identification candidate information memory unit as the objects to be identified.

In the authenticating system, preferably, the authenticating apparatus may include a memory control unit of at least one of the identification candidate information memory unit and the reference biometric information memory unit, and wherein the authenticating apparatus compares the reference biometric information with the biometric information to be input and, if both are determined not to be biometric information of the same user in view of the similarity of both, the memory control unit erases the candidate information from the identification candidate information memory unit and the reference biometric information from the reference biometric information memory unit and the authenticating apparatus uses the registered biometric information present in the storage device as the objects to be identified.

In the authenticating system, preferably, the authenticating apparatus may include an information synthesizing unit to synthesize the biometric information input from the terminal device and the reference biometric information stored in the reference biometric information memory unit, and wherein the authenticating apparatus, in a case of determining the users to be the same, causes the information synthesizing unit to synthesize the biometric information to be input and the reference biometric information stored in the reference biometric information memory unit and uses the synthesized biometric information for the identification.

In the authenticating system, preferably, the authenticating apparatus may perform identification using all pieces of the registered biometric information present in the storage device as objects to be identified for the biometric information to be input when, as a result of using the candidate information memorized in the identification candidate information memory unit as the objects to be identified, identity candidate is not identified from the candidate information.

The authenticating system may preferably further include a notifying unit to notify information of the registrant identified as the user oneself.

According to the embodiments of the present invention, the following effects can be obtained:

(1) Even if plural candidates are produced for input biometric information of a user, since the biometric information to be input next time is compared with such narrowed-down candidates, a shorter time of the authenticating processing and high-accuracy identity determination can be realized.

(2) In the 1-to-N identification, when false rejection occurs due to a poor input condition, etc., limiting registered information as objects to be identified at the time of the second-time or subsequent input, using the first-time identification information, enables shortening authenticating time in total.

As described above, while the most preferred embodiments, etc., of the present invention have been described, the present invention is not limited to the above description but, needless to say, various variations and modifications may be made by those skilled in the art based on the intent of the invention described in the scope of claims or disclosed in the best mode for carrying out the invention and it goes without saying that such variations and modifications are included within the scope of the present invention.

The embodiments of the present invention relate to authentication of authenticating on the basis of biometric information whether a user is a registrant, enable realizing a shorter time of authentication processing and high-accuracy identity determination even if plural candidates are produced for input biometric information of the user, and are applicable to and useful for portable information devices such as a cellular phone, a personal computer, and other electronic devices, etc.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An authenticating apparatus that authenticates whether a user is a registrant based on biometric information, the apparatus comprising:
a biometric information input unit to input the biometric information of the user;
a registered information memory unit to memorize, together with a single or plural registrants of the biometric information, registered biometric information for each of the registrants;
an identification candidate information memory unit to memorize candidate information representing registrants selected from the registrants of the registered information memory unit; and
an identifying unit to compare the biometric information input to the biometric information input unit and the registered biometric information of the registered information memory unit to decide on a single registrant or select plural registrants based on similarity, and, when plural registrants are selected, memorize the plural registrants in the identification candidate information memory unit as candidate information to use the candidate information as objects to be identified for biometric information of a subsequent input.

2. The authenticating apparatus of claim 1, wherein
the identifying unit compares the biometric information to be input and the registered biometric information memorized in the identification candidate information memory unit as the candidate information and if, based on the similarity of both, plural registrants are extracted from the registered biometric information, updates the candidate information of the identification candidate information memory unit by the plural registrants as latest candidate information.

3. The authenticating apparatus of claim 1, further comprising:
a reference biometric information memory unit to memorize the biometric information input from the biometric information input unit as reference biometric information, wherein
the identifying unit compares the reference biometric information memorized in the reference biometric information memory unit and the biometric information input by the biometric information input unit and, if both are determined to be biometric information of the same user in view of similarity, uses the candidate information memorized in the identification candidate information memory unit as the objects to be identified.

4. The authenticating apparatus of claim 3, further comprising:
a memory control unit in the identification candidate information memory unit and/or the reference biometric information memory unit, wherein
the identifying unit compares the reference biometric information with the biometric information input by the biometric information input unit and, if both are determined not to be biometric information of the same user in view of the similarity, the memory control unit erases the candidate information from the identification candidate information memory unit and the reference biometric information from the reference biometric information memory unit, and the identifying unit uses the registered biometric information present in the registered information memory unit as the objects to be identified.

5. The authenticating apparatus of claim 3, further comprising:
an information synthesizing unit to synthesize the biometric information input from the biometric information input unit and the reference biometric information stored in the reference biometric information memory unit, wherein
the identifying unit, in a case of determining users to be the same, causes the information synthesizing unit to synthesize the input biometric information and the reference biometric information stored in the reference biometric information memory unit and uses the synthesized biometric information for identification.

6. The authenticating apparatus of claim 1, wherein
the identifying unit performs identification using all pieces of the registered biometric information present in the registered information memory unit as objects to be identified for the biometric information to be input when, as a result of using the candidate information memorized in the identification candidate information memory unit as the objects to be identified, identity candidate is not identified from the candidate information.

7. The authenticating apparatus of claim 1, further comprising:
a notifying unit to notify information representing the registrant who is decided and/or the registrants who is selected.

8. An authenticating system comprising:
a terminal device to input biometric information of a user;
a storage device to memorize, together with a single or plural registrants of the biometric information, registered biometric information for each of the registrants; and
an authenticating apparatus to compare the biometric information of the user input to a biometric information input unit of the terminal device and the registered biometric information of the storage device, decide on a single registrant or select plural registrants based on similarity, and, when plural registrants are selected, uses the selected registrants as objects to be identified for biometric information of a subsequent input.

9. The authenticating system of claim 8, wherein
the authenticating apparatus includes an identification candidate information memory unit to memorize candidate information, and wherein
the authenticating apparatus compares the biometric information input to the terminal device and the registered biometric information memorized in the identification candidate information memory unit and if, based on the similarity of both, plural registrants are extracted from the registered biometric information, updates the candidate information of the identification candidate information memory unit by the plural registrants as latest candidate information.

10. The authenticating system of claim 9, wherein
the authenticating apparatus includes a reference biometric information memory unit to memorize the biometric information input to the terminal device as reference biometric information, and wherein
the authenticating apparatus compares the reference biometric information memorized in the reference biometric information memory unit and the biometric information to be input and, if both are determined to be biometric information of the same user in view of similarity of both, uses the candidate information memorized in the identification candidate information memory unit as the objects to be identified.

11. The authenticating system of claim 10, wherein
the authenticating apparatus includes a memory control unit of at least one of the identification candidate information memory unit and the reference biometric information memory unit, and wherein
the authenticating apparatus compares the reference biometric information with the biometric information to be input and, if both are determined not to be biometric information of the same user in view of the similarity of both, the memory control unit erases the candidate information from the identification candidate information memory unit and the reference biometric information from the reference biometric information memory unit and the authenticating apparatus uses the registered biometric information present in the storage device as the objects to be identified.

12. The authenticating system of claim 10, wherein
the authenticating apparatus includes an information synthesizing unit to synthesize the biometric information input from the terminal device and the reference biometric information stored in the reference biometric information memory unit, and wherein
the authenticating apparatus, in a case of determining users to be the same, causes the information synthesizing unit to synthesize the biometric information to be input and the reference biometric information stored in the reference biometric information memory unit and uses the synthesized biometric information for the identification.

13. The authenticating system of 9, wherein
the authenticating apparatus performs identification using all pieces of the registered biometric information present in the storage device as objects to be identified for the biometric information to be input when, as a result of using the candidate information memorized in the identification candidate information memory unit as the objects to be identified, identity candidate is not identified from the candidate information.

14. The authenticating system of claim 8, further comprising:
a notifying unit to notify information of the registrant identified as the user oneself.

15. An authenticating method of authenticating whether a user is a registrant based on biometric information, the method comprising:
a biometric information inputting process to input the biometric information of the user;
a registered information memorizing process to memorize, together with a single or plural registrants of the biometric information, registered biometric information for each of the registrants;
an identification candidate information memorizing process to memorize candidate information representing registrants selected from the registrants; and
an identifying process to compare the biometric information of the user to be input and the registered biometric information, decide on a single registrant or select plural registrants based on similarity, and, when plural registrants are selected, memorize the plural registrants as candidate information and using the candidate information as objects to be identified for biometric information of a subsequent input.

16. A computer-readable recording medium having recorded thereon an authenticating program executed by a computer, the program comprising:
capturing biometric information of a user to be input;
memorizing, together with a single or plural registrants of the biometric information, registered biometric information for each of the registrants;
memorizing candidate information representing registrants selected from the registrants; and
comparing the biometric information of a user to be input and the registered biometric information to decide on a single registrant or select plural registrants based on similarity, and, when plural registrants are selected, memorizing the plural registrants as candidate information to use the candidate information as objects to be identified for biometric information of a subsequent input.
